(19) United States
(12) Patent Application Publication
(10) Pub. No.: US 2025/0055948 A1
(43) Pub. Date: Feb. 13, 2025

(54) IMAGE PROCESSING APPARATUS, CONTROL METHOD THEREOF, AND MEDIUM

(71) Applicant: CANON KABUSHIKI KAISHA, Tokyo (JP)

(72) Inventor: KEN TOKITA, Kanagawa (JP)

(21) Appl. No.: 18/794,089

(22) Filed: Aug. 5, 2024

(30) Foreign Application Priority Data
Aug. 10, 2023 (JP) 2023-131467

(51) Int. Cl. H04N 1/00

(52) U.S. Cl. CPC H04N 1/00244; H04N 1/00331; H04N 1/00408; H04N 2201/0094

(57) ABSTRACT

An image processing apparatus can communicate with a server providing a chat service. The apparatus obtains image data of a digitalized document, transmits a character string extracted from the image data to the server and receives a correction for the character string from the server, and corrects the character string according to the correction. The character string is used in information for identifying a file including the image data from which the character string was extracted.

### BACKGROUND OF THE INVENTION

### Field of the Invention

The present invention relates to an image processing apparatus, a control method thereof, and a medium.

### Description of the Related Art

In the field of known information processing apparatuses such as a multi-function peripheral (MFP), a method of converting image data obtained by scanned a document, data received from a fax, and the like into a file and transmitting and storing the file in a storage server on a network is widely used. When file-converted data is stored, the data is also automatically distributed to a folder. For example, Japanese Patent Laid-Open No. 2021-140328 discloses a technique for automatically generating a file name according to a preset file naming rule. In the technique disclosed in Japanese Patent Laid-Open No. 2021-140328, as file naming rules, “document type”, “underscore”, “and “company name” are each set. In this case, “Quote” and “AACompany” are extracted as character strings relating to “document type” and “company name” from scanned image data, and the file name “Quote_AACompany” is generated.

With the technique disclosed in Japanese Patent Laid-Open No. 2021-140328, in the case of confirming extracted character strings and performing correction operations using an MFP, the user has exclusive access to the MFP during the time until the extracted character strings are displayed on the MFP control panel and while the correction operation is being performed.

### SUMMARY OF THE INVENTION

The present invention provides a technique for transmitting an extracted character string to a chat service and confirming and correcting the extracted character string within the chat service.

The present invention has the following configuration. An aspect of the present invention provides an image processing apparatus that can communicate with a server providing a chat service, comprising: at least one memory storing instructions; and at least one processor that is in communication with the at least one memory and that, when executing the instructions, cooperates with the at least one memory to execute processing, the processing including obtaining image data of a digitalized document, transmitting a character string obtained via character recognition processing on the image data to the server and receive a correction for the character string from the server, and correcting the character string according to the correction, and the character string is used in information for identifying a file including the image data from which the character string was extracted.

The present invention can provide a technique for transmitting an extracted character string to a chat service and confirming and correcting the extracted character string within the chat service.

Further features of the present invention will become apparent from the following description of exemplary embodiments with reference to the attached drawings.

### BRIEF DESCRIPTION OF THE DRAWINGS

FIG. 1 is a diagram illustrating the overall configuration of an image processing system.

FIG. 2 is a block diagram illustrating the hardware configuration of an MFP.

FIG. 3 is a block diagram illustrating the hardware configuration of an MFP cooperative server and a transmission destination service.

FIG. 4 is a block diagram illustrating the software configuration of the image processing system.

FIG. 5 is a diagram illustrating an example of a scan template list screen.

FIG. 6 is a diagram illustrating an example of a scan profile settings screen.

FIG. 7 is a diagram illustrating an example of a file naming rule setting screen.

FIG. 8 is a diagram illustrating an example of a file naming rule setting screen.

FIG. 9 is a diagram illustrating an example of a file naming rule setting screen.

FIG. 10 is a diagram illustrating an example of a scan profile execution screen.

FIG. 11 is a diagram illustrating an example of an authorization settings screen.

FIG. 12 is a sequence diagram illustrating the flow of the processing between devices.

FIG. 13 is a diagram illustrating an example of a scan screen.

FIG. 14 is a diagram illustrating an example of an extraction result information confirmation screen on an MFP screen.

FIG. 15 is a diagram illustrating an example of the extraction result information confirmation screen on a chat service.

FIG. 16 is a diagram illustrating an example of the extraction result information confirmation screen on the chat service.

FIG. 17 is a flowchart illustrating in detail extraction result information transmission processing for the chat server.

FIG. 18 is a flowchart of processing by the chat service.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

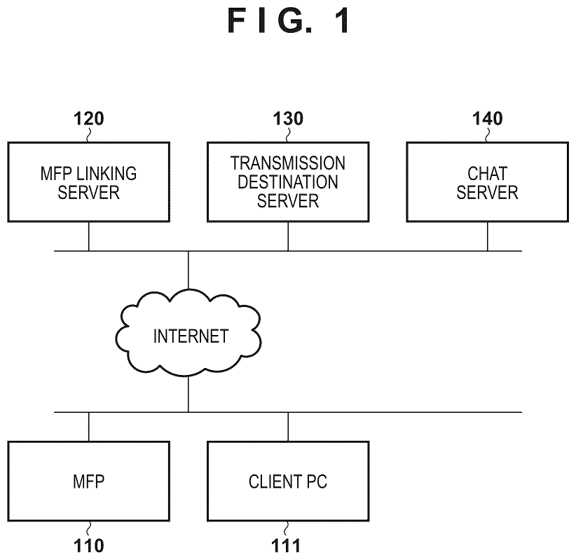

FIG. 1 is a diagram illustrating the overall configuration of an information processing system according to the present embodiment. The information processing system includes a multi-function peripheral (MFP) 110, a client PC 111, and server apparatuses 120, 130, and 140 that provide a cloud service on the Internet. The MFP 110 and the client PC 111 are communicatively connected to each apparatus providing various types of services on the Internet via a local area network (LAN).

The MFP 110 is an example of an information processing apparatus or an image processing apparatus with a scan function. The MFP 110 is a multi-function peripheral with a plurality of functions including, in addition to a scan function, a print function, and a box storage function for storing received or scanned data in a folder. The client computer (client PC) 111 is an information processing apparatus such as a desktop terminal or a mobile terminal that can receive a provided cloud service via the Internet. The server apparatuses 120, 130, and 140 are information processing apparatuses each providing a cloud service.

The server apparatus 120 according to the present embodiment provides a cloud service for performing image analysis of a scanned image received from the MFP 110 and transferring a request from the MFP 110 to the server apparatus 130 and 140 providing a different service. Hereinafter, the cloud service provided by the server apparatus 120 will be referred to as the “MFP cooperative service”. The MFP cooperative server may be referred to the image processing apparatus.

The server apparatus 130 provides a cloud service and an email service for storing file data received via the Internet in a predetermined folder and providing a storage file in accordance with a request from a web browser of the client PC 111. Hereinafter, the cloud service provided by the server apparatus 130 will be referred to as the “transmission destination service”.

The server apparatus 140 provides a cloud service and a collaboration service for displaying file data or character string information received via the

Internet and sharing information in accordance with a request from a web browser of the client PC 111. Hereinafter, the cloud service provided by the server apparatus 140 will be referred to as the “chat service”. In the present embodiment, the server apparatus 120 providing the MFP cooperative service is referred to as the “MFP cooperative server”, the server apparatus 130 providing the transmission destination service is referred to as the “transmission destination server”, and the server apparatus 140 providing the chat service is referred to as the “chat server”.

According to the present embodiment, chat means a service provided by the chat server 140 that enables a real-time interaction by displaying character strings entered by a user and accepting the input of character strings in relation to this. In the present example, one user is a piece of software called a bot, and the other user is a user for supervising digitalization of a document.

The information processing system according to the present embodiment includes the MFP 110, the client PC 111, the MFP cooperative server 120, the transmission destination server 130, and the chat server 140, but the configuration is not limited to this. For example, the MFP 110 may be also provided with the functions of the client PC 111 and the MFP cooperative server 120. Also, the MFP cooperative server 120, the transmission destination server 130, and the chat server 140 may be deployed on a LAN instead of the Internet. Also, the transmission destination server 130 may be used in the case of attaching a scanned image of a document to an email and transmitting it, instead of an email server or the like. Furthermore, the MFP cooperative server 120, the transmission destination server 130, and the chat server 140 may not each be independent services.

### Hardware Configuration of MFP 110

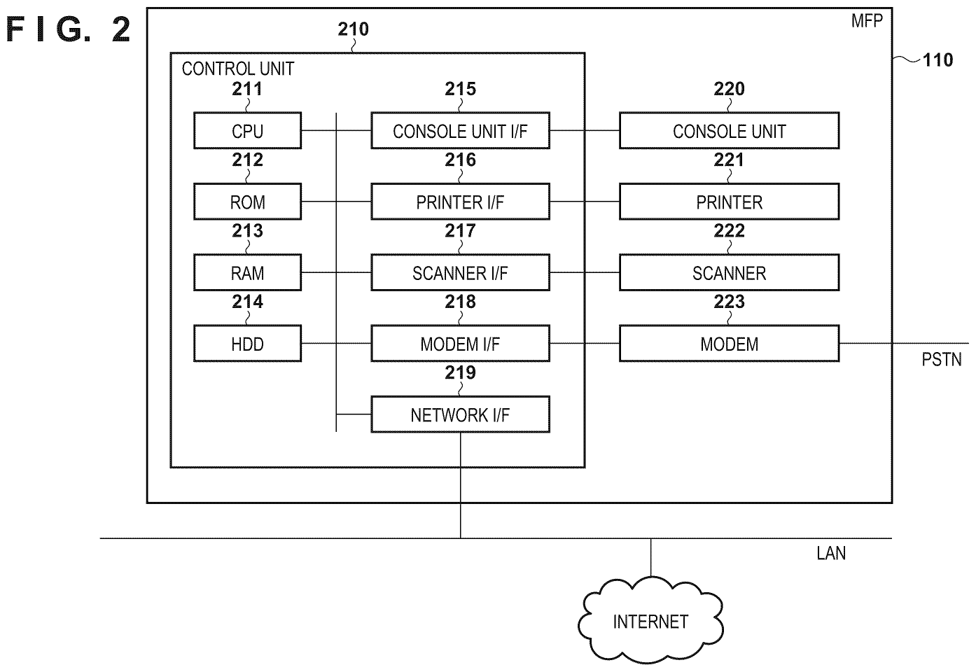

FIG. 2 is a block diagram illustrating the hardware configuration of the MFP 110. The MFP 110 includes a control unit 210, an operation unit 220, a printer unit 221, a scanner unit 222, and a modem 223. The control unit 210 includes the following units 211 to 219 and controls the entire operations of the MFP 110. A CPU 211 reads out and executes a control program (a program corresponding to the various types of functions illustrated in the software configuration diagram below) stored in a ROM 212. A RAM 213 is used as a temporary storage area, for example, the main memory of the CPU 211, a working area, and the like. Note that in the present embodiment, the single CPU 211 uses a single memory (the RAM 213 or an HDD 214) to execute the processing illustrated in the flowchart described below. However, the present invention is not limited thereto. For example, a plurality of CPUs and a plurality of RAMS or HDDs may cooperate to execute the processing.

The HDD 214 is a large capacity storage unit that stores image data and various programs. A console unit I/F 215 is an interface that connects the operation unit 220 and the control unit 210. The operation unit 220 is provided with a touch panel, a keyboard, or the like and receives operations, inputs, and instructions from a user. Note that a touch operation on a touch panel includes an operation by a finger of a person and an operation by a touchpen. The target for touching is a control or object such as a displayed button, and touch in the context of a keyboard operation may be press or the like. A printer I/F 216 is an interface that connects the printer unit 221 and the control unit 210. Image data for printing is transferred from the control unit 210 to the printer unit 221 via the printer I/F 216 and is printed on a printing medium.

A scanner I/F 217 is an interface that connects the scanner unit 222 and the control unit 210. The scanner unit 222 reads a document set on a non-illustrated platen or automatic document feeder (ADF) and generates scanned image data, with the image data then being input to the control unit 210 via the scanner I/F 217. The scanned image data generated by the scanner unit 222 can be printed (copy output) by the printer unit 221, stored in the HDD 214, and information transmission can be performed by transmitting the image data as a file or an email to an external apparatus such as the MFP cooperative server 120 via the LAN. A modem I/F 218 is an interface that connects the modem 223 and the control unit 210. The modem 223 performs facsimile communication of image data between facsimile machines (not illustrated) on the PSTN. A network I/F 219 is an interface that connects the control unit 210 (MFP 110) to the LAN. The MFP 110 transmits image data and information to the services on the Internet and receives various types of information using the network I/F 219. The hardware configuration of the MFP 110 described above is an example, and other units may be provided as necessary or one or more of the units may not be included.

### Hardware Configuration of Client PC and Server Apparatus

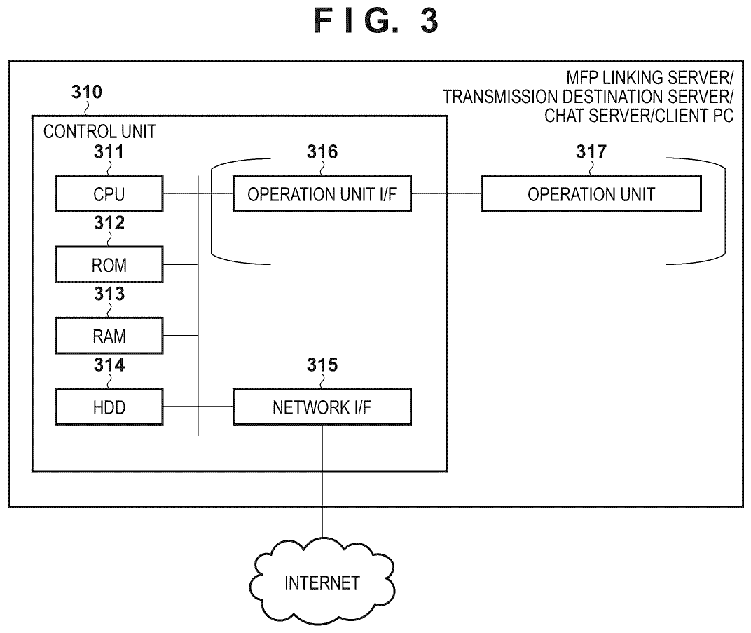

FIG. 3 is a block diagram illustrating the hardware configuration of the client PC 111, the MFP cooperative server 120, and the transmission destination server 130. The client PC 111, the MFP cooperative server 120, the transmission destination server 130, and the chat server 140 are each constituted by a CPU 311, a ROM 312, a RAM 313, an HDD 314, a network I/F 315, and an operation unit I/F 316.

The CPU 311 reads out and executes a control program stored in the ROM 312 or the RAM 313 to execute various types of processing and control the overall operation. The RAM 313 is used as a temporary storage area, for example, the main memory of the CPU 311, a working area, and the like. The HDD 314 is a large capacity storage unit that stores image data and various programs. The network I/F 315 is an interface that connects the client PC 111, the MFP cooperative server 120, the transmission destination server 130, and the chat server 140 to the Internet. If the network I/F 315 is an interface for a local network, each apparatus connects to the Internet via the local network. The MFP cooperative server 120, the transmission destination server 130, and the chat server 140 receive various processing requests from other apparatuses (the MFP 110, the client PC 111, and the like) via the network I/F 315 and send back processing results in accordance with the requests. The operation unit I/F 316 and an operation unit 317 are device components in the PC 111. The operation unit I/F 316 is an interface that connects the operation unit 317 and a control unit 310.

In addition to these, the client PC 111 includes a display (display unit) that displays images and a display adapter that controls the display. These do not have to be provided in the server. The display converts various pieces of information generated and obtained by a program executed by the client PC 111 into images and displays them.

### Software Configuration of Information Processing System

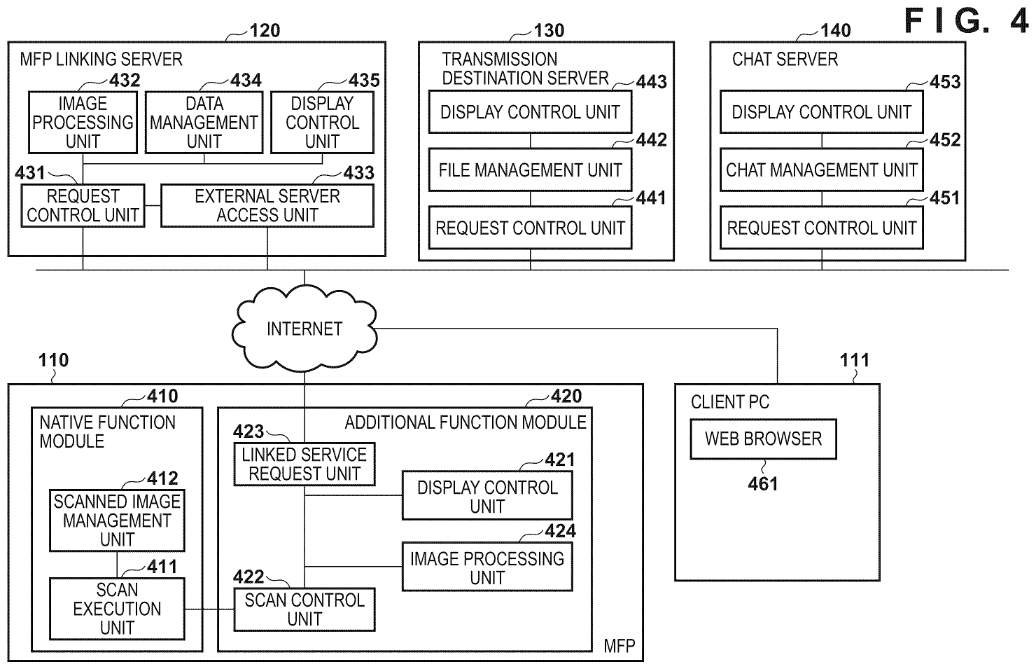

FIG. 4 is a block diagram illustrating the software configuration of the information processing system according to the present embodiment. The software configurations corresponding to the roles of the MFP 110, the MFP cooperative server 120, the transmission destination server 130, the chat server 140, and the client PC 111 will be described in order. Note that below, of the functions of each apparatus, only functions involved in the processing from a scanned image obtained by a document being scanned by the MFP 110 being converted into a file to the file being transmitted to the transmission destination server 130 and the chat server 140 via the MFP cooperative server 120 will be described. Here, a file being obtained by conversion may be referred to as digitization, as the converted file is electronic data with a predetermined file format.

### Software Configuration of MFP

The functional modules of the MFP 110 are broadly categorized into two modules, a native function module 410 and an additional function module 420. The native function module 410 are applications provided as standard to the MFP 110, and the additional function module 420 are applications additionally installed on the MFP 110. The additional functional module may also be referred to as the added function module. The additional function module 420 is an application based on Java (registered trademark) and can easily implement additional functions to the MFP 110. Note that in the MFP 110, other not-illustrated additional applications may be installed.

The native function module 410 includes a scan execution unit 411 and a scanned image management unit 412. Also, the additional function module 420 includes a display control unit 421, a scan control unit 422, a cooperative service request unit 423, and an image processing unit 424.

The display control unit 421 displays the user interface (UI) screen for receiving various types of user operations via a touch panel of the operation unit 220. Various types of user operations include an input of login authentication information to access the MFP cooperative server 120, scan settings, transmission destination information settings, scan file attribute information settings, a scan start instruction, a transmit instruction, and the like.

The scan control unit 422, in response to a user operation (for example, the press of a “start scan” button) performed on the UI screen, instructs the scan execution unit 411 to execute scanning processing together with the scan settings information. The scan execution unit 411 causes a scanner unit 240 to execute a reading operation on a document via the scanner I/F 217 according to a scan processing execution instruction from the scan control unit 422 and generates scanned image data. The generated scanned image data is stored in the HDD 214 by the scanned image management unit 412. At this time, the information of the scanned image identifier for uniquely specifying the stored scanned image data is communicated to the scan control unit 422. The scanned image identifier includes numbers, symbols, alphabet characters, and the like for uniquely identifying the scanned image in the MFP 110. The scan control unit 422 uses the scanned image identifier described above to obtain the scanned image data to be converted into a file from the scanned image management unit 412. Then, an instruction is sent to the cooperative service request unit 423 for it to send a request to the MFP cooperative server 120 for the processing required for conversion to a file and file transmission.

The cooperative service request unit 423 sends a request to the MFP cooperative server 120 for various types of processing and receives responses. The various types of processing include, for example, login authentication, scanned image analysis, scanned image data transmission, and the like. REST, SOAP, or a similar communication protocol is used for the communication with the MFP cooperative server 120.

The image processing unit 424 generates an attribute used on the UI screen displayed by the display control unit 421 including the predetermined image processing to be executed on the scanned image data, the transmission destination, and the file name.

### Software Configuration of Server Apparatus

First, the software configuration of the MFP cooperative server 120 will be described. The MFP cooperative server 120 includes a request control unit 431, an image processing unit 432, an external service access unit 433, a data management unit 434, and a display control unit 435. The request control unit 431 is on standby in a state ready to receive a request from an external apparatus and, in response to the contents of a received request, sends an instruction to execute a predetermined processing to the image processing unit 432, the external service access unit 433, and the data management unit 434. The image processing unit 432 executes image editing processing such as rotation and gradient correction on the scanned image data transmitted from the MFP 110. Processing including the analysis of scanned image data and extraction of attribute information is also executed. The external service access unit 433 executes processing requests for the transmission destination server 130 and the chat server 140. With the cloud service, various interfaces are presented for storing file information in the transmission destination service 130 and the chat service 140 using a protocol such as REST or SOAP, obtaining stored file information, and the like. The external service access unit 433 uses the presented interfaces to execute processing requests for the transmission destination server 130 and the chat service 140. The data management unit 434 holds and manages user information, various types of settings data, and the like managed by the MFP cooperative server 120. The display control unit 435 receives a request from the web browser running on the MFP 110 or the client PC 111 connected via the Internet and replies with screen configuration information (HTML, CSS, or the like) required for screen display. The user can confirm the registered user information and change the scan settings and settings relating to the transmission destination information via the screen displayed in the web browser.

Next, the software configuration of the transmission destination server 130 will be described. The transmission destination server 130 includes a request control unit 441, a file management unit 442, and a display control unit 443. The request control unit 441 is on standby in a state ready to receive a request from an external apparatus and, in response to a request from the MFP cooperative server 120 according to the present embodiment, instructs the file management unit 442 to store a received file or read out a stored file. Then, a response to the request is send back to the MFP cooperative server 120. The file management unit 442 stores a file or reads out a stored file in accordance with the instruction. The display control unit 443 receives a request from the web browser running on the MFP 110 or the client PC 111 connected via the Internet and replies with screen configuration information (HTML, CSS, or the like) required for screen display. The user can confirm and obtain stored files via the screen displayed in the web browser.

Next, the software configuration of the chat server 140 will be described. The chat server 140 includes a request control unit 451, a chat management unit 452, and a display control unit 453. The request control unit 451 is on standby in a state ready to receive a request from an external apparatus and, in response to a request from the MFP cooperative server 120 according to the present embodiment, stores received file information and analysis result information in the chat management unit 452. Also, information input by a user on a screen displayed by the display control unit 453 described below is stored. The display control unit 453 receives a request from the web browser running on the MFP 110 or the client PC 111 connected via the Internet and replies with screen configuration information (HTML, CSS, or the like) required for screen display. The user can confirm file information and analysis result information via the screen displayed in the web browser, and a user can enter a response to such information.

The client PC 111 is provided with a web browser 461 as an application program executed on the client PC 111. The web browser 461 transmits various types of requests in HTTP to each server and receives responses to the requests. A response is data described in HTML or the like and may include screen data corresponding to a designated URI as well as processing results for a request, scripts, and the like. In order to perform a request for the cooperative service, display control, or the like via the web browser 461, the client PC 111 also may be provided with the same functional module as the additional function module 420 described above. The user interface (UI) of each server is implemented by the web browser 461.

### Scan Profile

A method of creating a scan profile will now be described. The user can easily implement a desired scan workflow by creating a scan profile in advance. Here, a scan workflow means a workflow (digitized task procedure) for transmitting data of a scanned image obtained by scanning a document such as a business form to a specific transmission destination (for example, the transmission destination server 130) under a specific condition. The information of the condition and transmission destination of each scan workflow is managed by the scan profile.

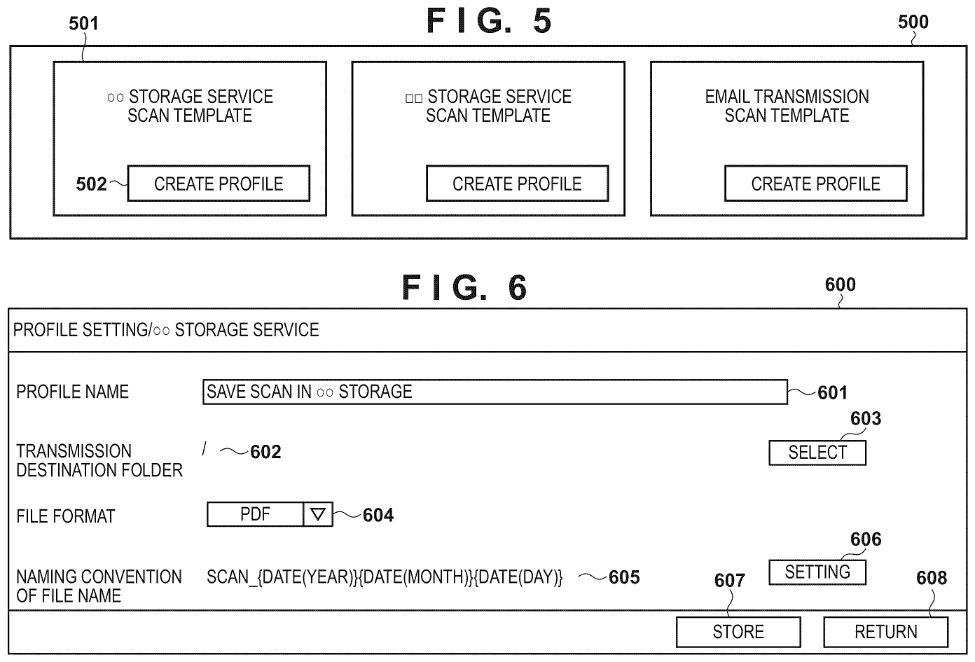

For example, the user can log into the MFP cooperative server 120 via the client PC 111 and display a UI screen such as that illustrated in FIG. 5 via a screen transition from a main screen (not illustrated) displayed after login. FIG. 5 illustrates an example of a UI screen (hereinafter referred to as the “template selection screen”) of a list of templates for creating a scan profile displayed on the operation unit 317 of the client PC 111. Via a template selection screen 500, any of the templates 501 displayed on the template selection screen 500 can be selected. The templates 501 may be prepared per use case, per work task type, or per transmission destination service. Also, a profile may be created by the user customizing all of the setting and not using a template. After the template 501 is selected, the user can press a “create profile” button 502 to display a UI screen such as that illustrated in FIG. 6.

FIG. 6 illustrates an example of a UI screen (hereinafter referred to as the “scan profile settings screen”) of the scan profile settings displayed on the operation unit 317 of the client PC 111. A scan profile settings screen 600 includes a scan profile name setting area 601, a transmission destination folder display area 602, and a transmission destination folder setting button 603. The scan profile settings screen 600 also includes a file format selection area 604, a file naming rule (file name naming convention) display area 605, a file naming rule setting area 606, a save button 607, and a back button 608.

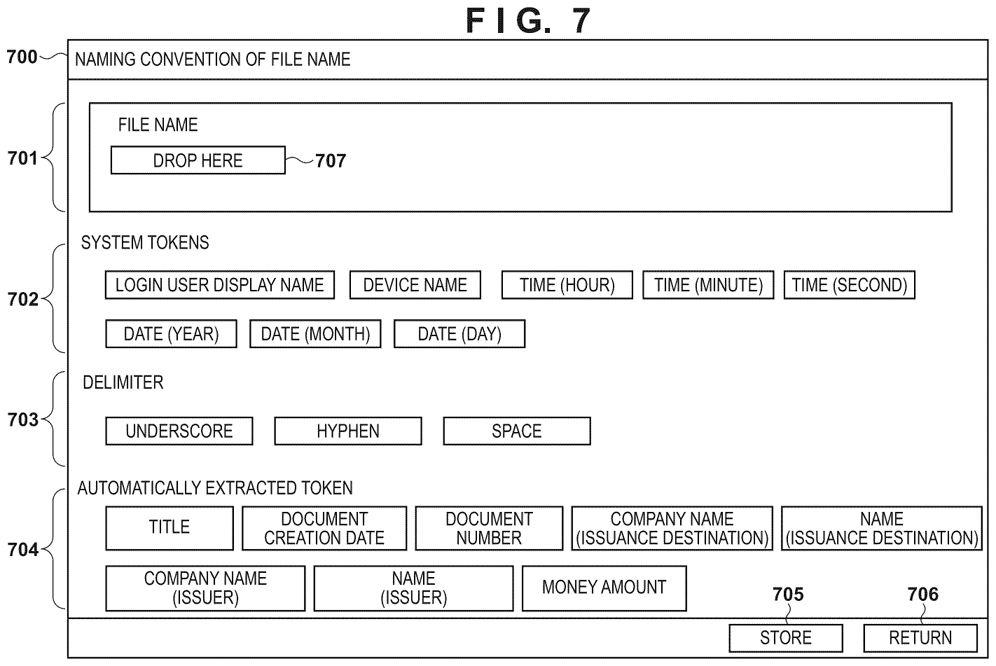

The scan profile name setting area 601 is where a scan profile name can be entered from a text field or the like. The enter scan profile name is displayed above the button for executing the scan profile described below. The transmission destination folder display area 602 displays the transmission destination folder path. When the transmission destination folder setting button 603 is pressed, the folder selection screen (not illustrated) is displayed, and the folder path of the selected folder is displayed in the transmission destination folder display area 602. By default, the route (“/”) of the transmission destination service is designated. The file format setting area 604 is where the file format (extension) of the scan file can be set. In the present embodiment, candidates for the file format are displayed in a pull-down menu, allowing for selection. The file name naming convention display area 605 displays the file naming rule of the scan file. The file name is identification information for identifying the file including the scanned image data and forms a part of the transmission destination information together with the folder where the file is stored. When the file naming rule setting button 606 is pressed, the file naming rule settings screen is displayed, and the file naming rule set on this screen is displayed in the file naming rule display area 605. The file naming rule settings screen will be described below in detail using FIGS. 7 to 9.

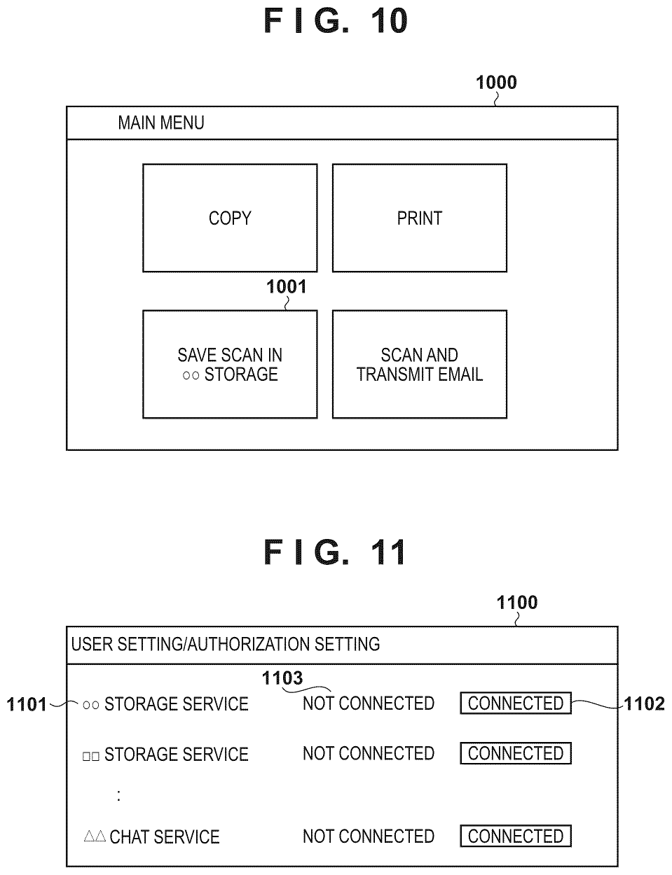

The information (scan profile) set on the scan profile settings screen is transmitted to the MFP cooperative server 120 in response to the “save” button 607 being pressed and managed by the data management unit 434. Also, the saved scan profile is displayed on a scan profile execution screen (described below) on the MFP 110. The scan profile execution screen will be described below in detail using FIG. 10. When a “back” button 608 is pressed, the profile which is currently edited and displayed in the scan profile name setting area 601 is discarded, and the setting processing ends.

### Setting of File Naming Rule

Next, setting the naming rule relating to a file name assigned when converting a scanned image or the like into a file will be described. In the example of the present embodiment described below, the file naming rule setting is performed by the client PC 111. FIG. 7 is a diagram illustrating an example of a UI screen (hereinafter referred to as the “file naming rule setting screen”) for the user to set the file naming rule displayed on the display (not illustrated) of the client PC 111. FIG. 7 illustrates one item that can be set via the scan profile settings screen (not illustrated). A file naming rule setting screen 700 illustrated in FIG. 7 indicates the default display state. The file naming rule setting screen 700 includes four areas: a rule edit area 701, a system token area 702, a character delimiter token area 703, and an automatically extracted token area 704. A token drop area 707 is provided in the rule edit area 701, and a “save” button 705 for confirming and saving the set file naming rule is provided on the lower portion of the screen.

In the present embodiment, “token” means a unit item for a user to designate a character string (including a symbol) used in properties information required when storing a file in the transmission destination server 130 while taking the attribute thereof into consideration. The token includes a general token (general item) corresponding to a character string with a predetermined attribute and a particular token (particular item) for automatically extraction of a character string corresponding to an attribute type from within a document. Note that an attribute of a character string described here can also be referred to as a classification based on the meaning of a character string. A system token and a character delimiter token described below correspond to a general token, and an automatically extracted token described below corresponds to a particular token. These tokens are represented as UI elements that are targeted by a user operation, such as a drag operation and a drop operation, on various types of setting screens that appear as described below.

The system token area 702, the character delimiter token area 703, and the automatically extracted token area 704 display a list of various types of tokens. Also, the rule edit area 701 displays the file naming rule generated using the various types of tokens. Here, the file naming rule includes information relating to the file name of the scan data and is set in advance by the user.

### Setting of Token

The user can select one of the tokens displayed in the system token area 702, the character delimiter token area 703, and the automatically extracted token area 704 via a drag operation and can perform a drop operation in a token drop area 707. By repeating this operation as necessary, a new file name is represented in a pseudo manner, which includes a character string corresponding to the tokens selected by the drag operation as the file name.

The system token area 702 is an area that displays tokens with user environmental variables such as “login user display name”, “time”, and “date” as attribute values. The character delimiter token area 703 is an area displaying tokens with character delimiters (symbols) such as “underscore” and “hyphen” as attribute values. The automatically extracted token area 704 is an area displaying tokens with character strings corresponding to attribute types extracted from an OCR result (recognized character string) of a scanned image as attribute values. Attribute types that can be selected by automatically extracted tokens and automatically extracted tokens will be described below in detail.

The information of the rule displayed in the rule edit area 701 is transmitted to the MFP cooperative server 120 in response to the “save” button 705 being pressed and managed by the data management unit 434. Also, the file naming rule display area 605 displays the set naming rule. When a “back” button 706 is pressed, the rule currently displayed in the rule edit area 701 is discarded, and the setting processing ends.

Here, the file naming rule according to the present embodiment will be confirmed. First, there are no particular constraints on the combination and order of the tokens that can be set as the file naming rule. For example, a rule including only a character delimiter token in the character delimiter token area 703 may be generated, and a rule using only the same system token can be generated.

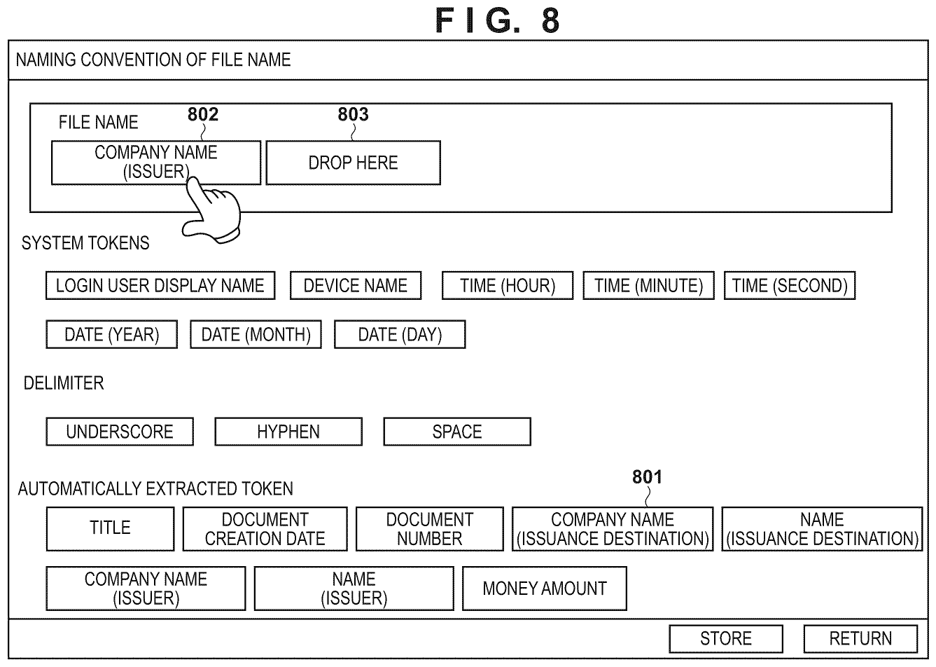

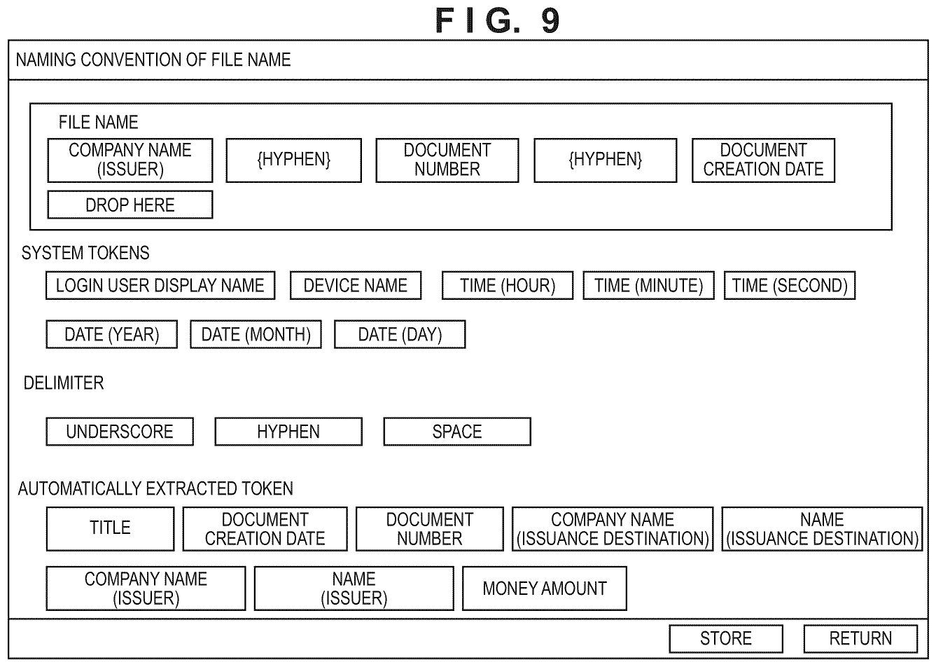

Next, a method for setting a file naming rule will be described using FIGS. 8 and 9. FIG. 8 illustrates a state of the file naming rule setting screen 700 when the user has dragged and dropped one of the automatically extracted system tokens from the automatically extracted token area 704 into the rule edit area 701. Specifically, a state is illustrated in which, of the plurality of automatically extracted tokens displayed in the automatically extracted token area 704, an automatically extracted token 801 with “company name (issuer)” as the attribute name is dropped in the token drop area 707. As seen in the rule edit area 701 in FIG. 8, at the position in the token drop area 707 when the user performed a drop operation, a new token 802 with “company name (issuer)” as the attribute name is disposed, and a new token drop area 803 is generated. In the state illustrated in FIG. 8, if one token is selected from the token groups in the various types of token areas 702 to 704 described above and dragged and dropped in the token drop area 803, another new token drop area is generated (not illustrated). Then, if another token is dragged and dropped in the newly generated token drop area, another token drop area is generated.

FIG. 9 illustrates a state of the file naming rule setting screen 700 after this task has been repeated a number of times. As seen in the rule edit area 701 in FIG. 9, four new tokens have been added, namely, a token with “hyphen” as the attribute name, a token with “document number” as the attribute name “, a token with “hyphen” as the attribute name, and a token with “document creation date” as the attribute name. Another token drop area has also been generated. In other words, the file naming rule set the file naming rule settings of FIG. 9 corresponds to “{company name (issuer)} {hyphen} {document number} {hyphen} {document creation date}”.

Note that with the tokens set in the rule edit area 701 as described above, adjacent tokens may be switched, a token may be inserted between tokens, and other positional changes may be made via a drag operation.

### Deleting a Token

Next, an example of a user deleting a token of the folder hierarchy set as described above will now be described. When the user performs a mouse-hover operation and places the pointer over one of the tokens displayed in the rule edit area 701, a “x” button is displayed above the token (not illustrated). The user can delete a token by pressing this “x” button.

A file name can be generated by disposing a token in the area described above, defining the naming convention of the file, and disposing a token extracted from a document according to the naming convention.

### Authorization Settings Screen

A method of allowing a connection between the MFP cooperative server 120 and the transmission destination server 130 and the chat server 140 will now be described. For example, the user can log into the MFP cooperative server 120 via the client PC 111 and display a UI screen such as that illustrated in FIG. 11 via a screen transition from a main screen (not illustrated) displayed after login.

FIG. 11 illustrates an example of a UI screen (hereinafter referred to as the “authorization settings screen”) of authorization settings for the transmission destination service and the chat service displayed on the operation unit 317 of the client PC 111. On this screen, the settings can be set to authorize the MFP cooperative service to access the transmission destination service and the chat service. An authorization settings screen 1100 includes a service name display area 1101, a service connect button 1102, and a service connection state display area 1103. The service name display area 1101 displays the names of the transmission destination services and chat services that the MFP cooperative service can connect to. When the service connect button 1102 is pressed, the target service authentication/authorization screen (not illustrated) is displayed. The user can set the authentication/authorization settings for the target service to authorize the MFP cooperative service to use the target service. The authorization settings are set using an OAuth mechanism. When the authorization settings are completed, the display of the service connection state display area 1103 switches from “not connected” to “connected”.

For example, when the privileges to access the transmission destination service and the chat service are given to a user, as information indicating these privileges, an authorization token is obtained from the server and held in the client PC 111. When the service connect button 1102 is pressed, the authorization token issued by the service is provided from the client PC 111 to the MFP cooperative service, and user privileges to access the service are given. This enables connection to the service. Note that the user authentication may be performed by an authentication server different from the chat server 140 and the transmission destination server 130, and the authentication server may issue the authorization token.

### Scan Profile Execution Flow

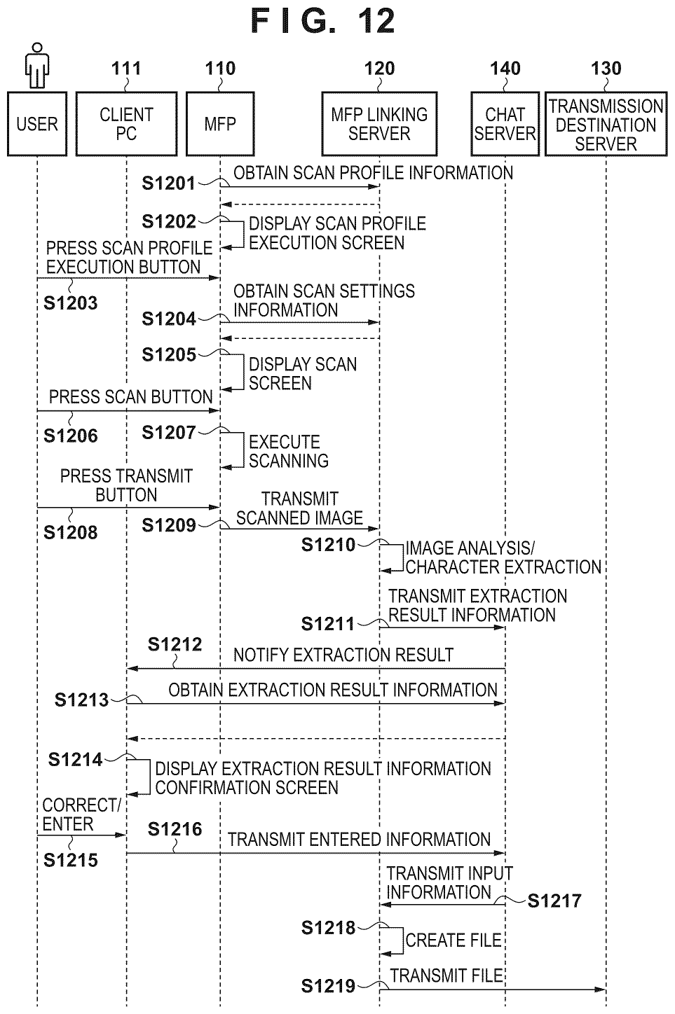

FIG. 12 is a sequence diagram illustrating the flow of processing between the apparatuses when scan profile is executed by the MFP 110 and a scanned image is converted into a file and transmitted to the transmission destination server 130. The present sequence starts with the user displaying the home screen on the MFP 110.

In S1201, the MFP 110 obtains scan profile information from the MFP cooperative service 120. In S1202, the MFP 110 displays the scan profile execution button. At this time, an additional application for transmitting the scan file to the transmission destination server is installed on the MFP 110 to display a button for executing the scan profile on the home screen (hereinafter, scan profile execution screen) of the MFP 110. Obtaining the scan profile in S1201 may be performed in response to the additional application being installed.

### Scan Profile Execution Screen

FIG. 10 illustrates an example of a UI screen for executing the generated scan profile. In the present embodiment, this is the home screen displaying applications executed by the MFP 110. On the same screen as the copy application and the print application, “save scan in ○○ to storage” is displayed as a scan profile execution button 1001. The scan profile execution button 1001 corresponds to the scan profile generated from the template 501 described above. When the scan profile execution button 1001 is pressed, the scan profile is executed. Now we will return to the description of the sequence.

When the user presses the scan profile execution button 1001 in S1203, in S1204, the MFP 110 obtains the scan settings information from the MFP cooperative service 120. In S1205, the MFP 110 displays the scan screen. As with the scan profile, for example, the scan settings information may be generated by the MFP cooperative server 120 using the client PC 111 as a terminal and stored.

### Scan Screen

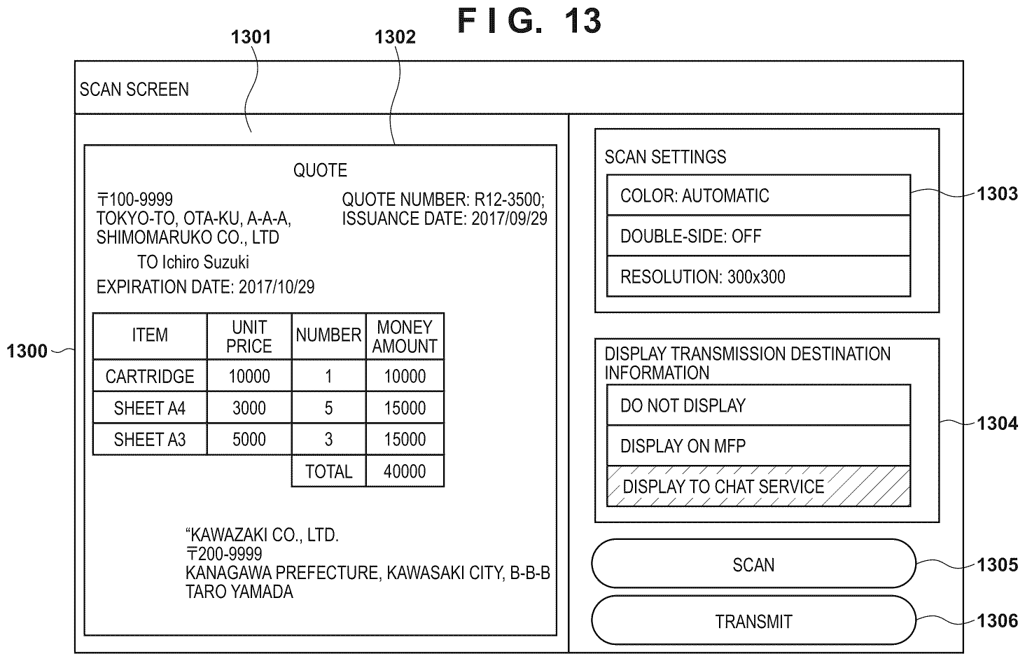

FIG. 13 is an example of a scan screen 1300 displayed on the operation unit 220 of the MFP 110. The scan screen 1300 is displayed when the scan profile execution button 1001 is pressed. The scan screen 1300 includes a preview area 1301, a scan settings portion 1303, a transmission destination information display mode setting 1304, a scan button 1305, and a transmit button 1306.

The preview area 1301 displays a preview image 1302 of the scanned document. When there is no scanned document, an image or message (both not illustrated) prompting the user to scan may be displayed here or this may be blank. The scan settings portion 1303 displays settings for scanning a document including color mode, double-sided setting, and resolution. The transmission destination information display mode setting 1304 allows the user to select whether or not to display the transmission destination folder set on the scan profile settings screen described above and the file name generated from the file name naming convention as transmission destination information before transmission. Also, where it is displayed can be selected in the case of displaying. In the present embodiment, as options for the transmission destination information display mode setting 1304, “do not display”, “display on MFP”, and “display via chat service” can be selected.

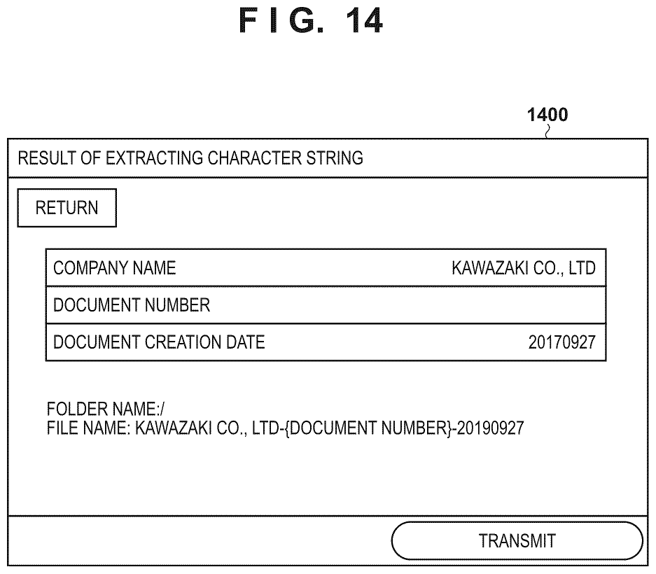

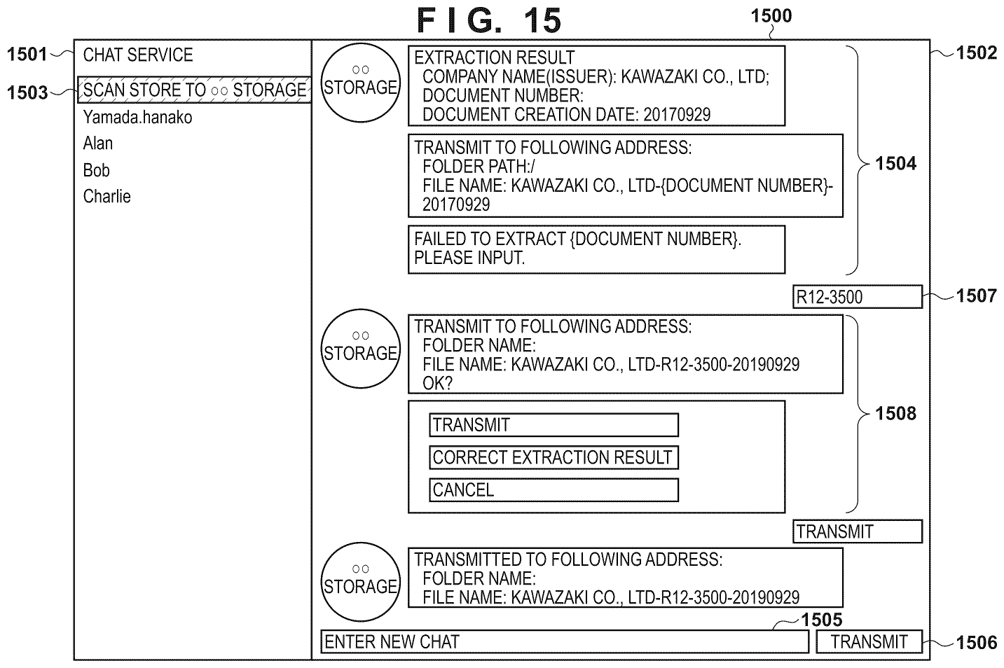

“Do not display” is an option in which, after scanning and transmission, the user transmits the file to the transmission destination server 130 without checking the transmission destination information generated by the MFP cooperative server 120. “Display on MFP” is an option in which the transmission destination information generated by the MFP cooperative server 120 is displayed on the operation unit 220 of the MFP 110. When “display on MFP” is selected and scanning is performed, the screen switches to a UI screen such as that illustrated in FIG. 14. The user can look at the UI screen displayed on the MFP 110, check the transmission destination information generated by the MFP cooperative server 120, change the transmission destination information as necessary, and touch the transmit button to transmit the file. The displayed transmission destination information will be described below in detail using FIG. 15. “Display via chat service” is an option in which the transmission destination information generated by the MFP cooperative server 120 is transmitted to the chat server 140 and displayed on the operation unit 317 of the client PC 111 connected to the chat service.

The scan button 1305 is a button for executing scanning. The transmit button 1306 is a button for transmitting the scan data to the MFP cooperative server 120. Also, on the UI screen of FIG. 14, a list of extracted character strings, which is the source of the generated file name, is displayed together with the names of tokens. Now we will return to the description of the sequence. The following flow describes an example in which “display via chat service” is selected for the transmission destination information display mode setting 1304.

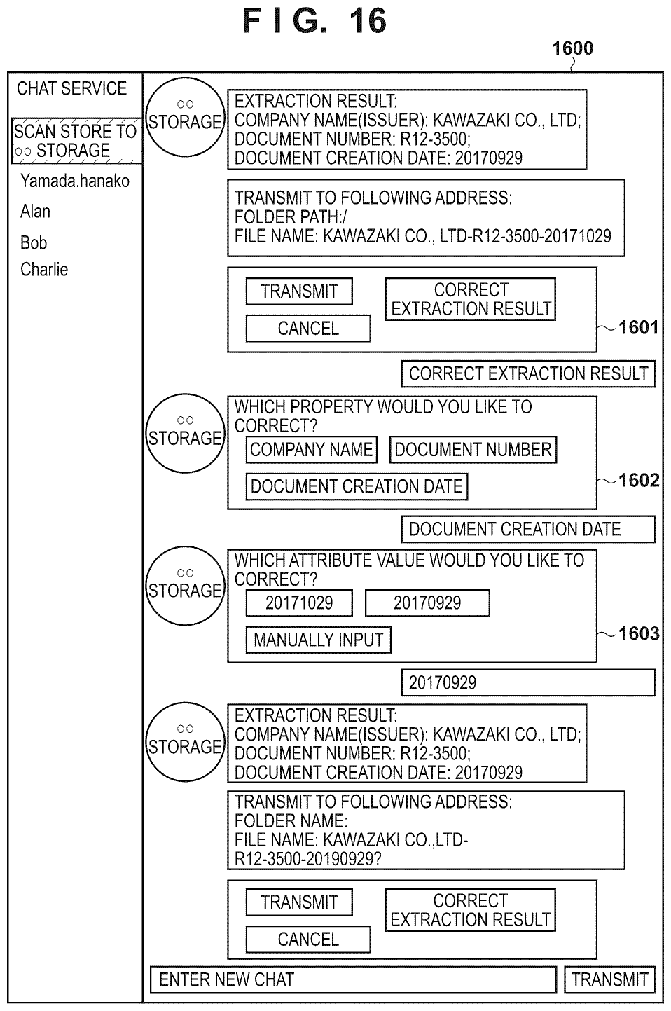

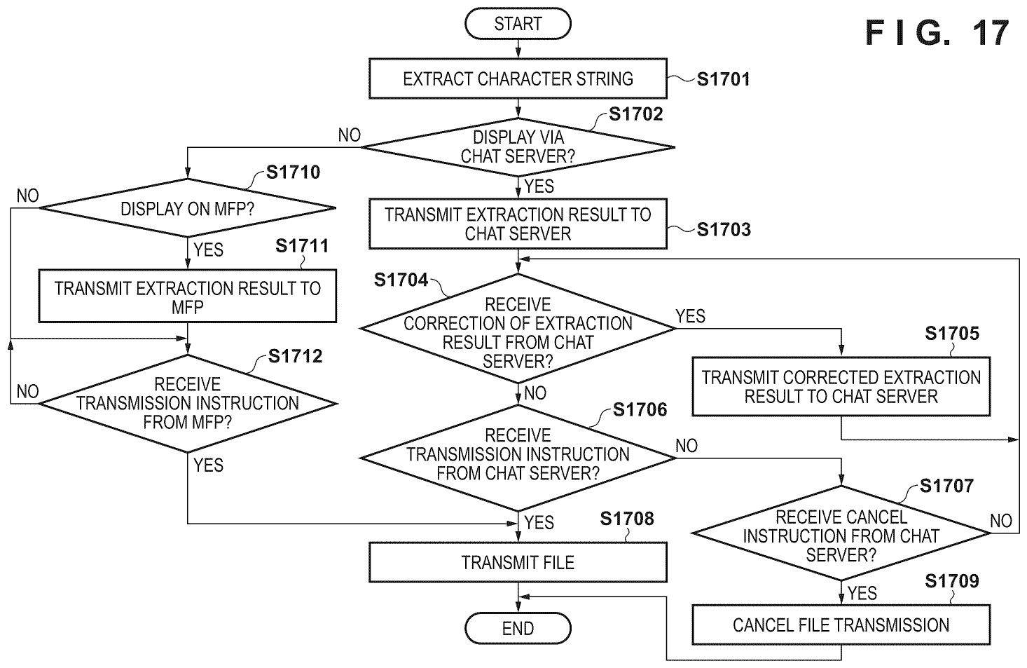

When a paper form to be scanned is set on a document platen glass or ADF by the user and the scan button 1305 is pressed in S1206, in S1207, the MFP 110 performs scanning using the scan settings set in the scan settings portion 1303. When the transmit button 1306 is pressed by the user in S1208, in S1209, the MFP 110 transmits a scanned image analysis request to the MFP cooperative server 120 together with the image generated via the scan processing. When the request control unit 431 of the MFP cooperative server 120 receives the scanned image analysis request in S1210, image analysis is performed by the image processing unit 432 of the MFP cooperative server 120 to extract characters. At this time, characters are extracted on the basis of the file name naming rule as described using FIG. 7. In S1211, the MFP cooperative server 120 transmits the extraction result information obtained from the data management unit via the external server access unit 433 to the chat server 140. The extraction result information includes the scanned image, the transmission destination folder information set via the scan profile described above, the file name generated according to the naming rule from the extracted characters, and the character extraction result. When the chat server 140 receives the extraction result information, a new chat room is generated, and the extraction result information is entered in a chat room as a new chat with a program called a chat bot as the poster. As illustrated in FIGS. 15 and 16, the chat bot can edit and transmit the extraction result interactively with the user.

In S1212, the chat management unit 452 of the chat server 140 notifies the client PC 111 of the reception of the extraction result information via the request control unit 451. At this time, the notification may be performed using a function of the chat service, API, a plug-in, or the like. For example, the notification may be performed via a client application of the chat server 140 installed on the client PC 111 or a web application on a browser and may be displayed via a pop-up (not illustrated). In S1213, when the notification is received, the client PC 111 transmits the extraction result information obtain request to the chat server 140 and obtains screen information with the extraction result information formed by the display control unit 453.

In S1214, the client PC 111 displays an extraction result information confirmation screen (described below) obtained from the chat server 140. At this time, a function of the chat service or API can be used to obtain the extraction result information and display the extraction result information. In S1215, the user confirms and corrects the extraction result information on the extraction result information confirmation screen via the client PC 111. In S1216, the client PC 111 transmits the entered information to the chat server 140. At this time, the entered information may be transmitted using a function of the chat service, API, a plug-in, or the like.

### Extraction Result Information Confirmation Screen

FIG. 15 is an example of an extraction result information confirmation screen 1500 displayed on the operation unit 317 of the client PC 111 or a non-illustrated display. The screen example is a result of extraction from a scanned document image 1302 of FIG. 13. The extraction result information confirmation screen 1500 includes a chat room selection area 1501, a chat room 1502, a chat input field 1505, and a chat transmit button 1506. The chat room selection area 1501 is an area that displays a list of the chat room names for selection. When the pop-up (not illustrated) notification in S1212 is clicked, a chat room “save scan in ○○ storage” 1503 is selected, and the name of the selected chat room is highlighted. The “save scan in ○○ storage” chat room is generated when the scan profile “save scan in ○○ storage” is executed and the chat server 140 receives this in S1211.

The chat room 1502 is an area for chatting between members belonging in the selected chat room. A member is a user actually using the chat service and may be a system called a chat bot. In the present embodiment, the members belonging to the chat room “save scan in ○○ storage” 1503 are the user logged into the chat service and the “save scan in ○○ storage” bot. The bot enters the extraction result information transmitted from the MFP cooperative service 120 into a chat room 1503 as chat 1504. In the present embodiment, first, as the extraction result, the attribute names of the automatically extracted tokens “company name (issuer)”, “document number”, and “document creation date” set in the file naming rule illustrated in FIG. 9 and an example of an extracted character string corresponding to the attribute names are entered into the chat. Also, as the transmission destination information, the item names of the “folder path” and “file name” and their values are entered into the chat. The folder path is a path set in the transmission destination folder display area 602 of the scan profile settings screen 600 of FIG. 6. The file name is the file name generated according to the set file name naming rule from the character string extracted from the scanned image. At this time, if a character string corresponding to “document number” cannot be extracted from the scanned image, the value for the extraction result of “document number” is left blank. Also, since the set file naming rule corresponds to “{company name (issuer)} {hyphen} {document number} {hyphen} {document creation date}”, the created file name is “Kawazaki Co., Ltd.-{document number}-20170929”. Of the tokens describing the file naming rule, the attributes (tokens) that are able to be extracted from the scanned image are substituted with the extracted character string, and the attributes that are unable to be extracted are substituted with the attribute name (token name).

Also, since the “document number” could not be extracted, a chat prompts for entry of the “document number”. This chat can be generated by fitting the corresponding attribute name into a fixed phrase in a case where the character string of the attribute cannot be extracted. Next, as a method of entering the “document number”, the user enters the value “R12-3500” for the “document number” into the chat input field 1505 and presses the chat transmit button 1506 to enter the entered value into the chat as with 1507. Then, when the bot receives the input from the user, transmission destination information re-generated using the entered value is entered into the chat (1508). Furthermore, as a subsequent action, the options “transmit”, “correct extraction result”, and “cancel” are entered into the chat. These options are functions of the chat service, and by selecting one of them, the selected content can be entered into the chat without the need for input of the chat input field. When “transmit” is selected, the scan file is transmitted to the transmission destination server 130 on the basis of the transmission destination information. When “cancel” is selected, the present scan flow can be canceled.

As described above, in S1215, the file name generated by the MFP cooperative server 120 is corrected as necessary, and the input information is transmitted to the chat server 140 in S1216. In a case where the bot is executed by the chat server 140, the chat input may be transmitted to the chat server 140 each time there is a user input. For example, if the input is the selection of an option, the selection target may be transmitted each time there is a selection, and if the input is a character string, the character string may be transmitted each time a code is input indicating the completion of the character string, for example. In this case, each time there is an input, chat based on the input is transmitted from the chat server 140 to the client PC 111 and displayed. On the other hand, the bot may be implemented via a script transmitted from the chat server 140 to the client PC 111 and may be executed by the client PC 111. In this case, the edit result based on the input up until when “transmit” is selected may be transmitted to the chat server 140. Now we will return to the description of the sequence.

The following flow describes an example in which an attribute value unable to be extracted is entered and, as a subsequent action, “transmit” is selected.

In S1217, the chat management unit 452 of the chat server 140 transmits a transmission instruction to the MFP cooperative service 120 via the request control unit 451. In a case where edit based on the chat has been added to the extraction result information, the input information (that is, the post-edit information) based on the chat is transmitted together with the transmission instruction. In S1217, the data management unit 434 of the MFP cooperative service 120 creates a file from the scanned image. In S1218, the data management unit 434 of the MFP cooperative service 120 transmits the created file to the transmission destination server 130 via an external server access unit 433 on the basis of the transmission information input by the chat server 140.

Also, in the present embodiment, in a case where “display via chat service” is selected for the transmission destination information display mode setting 1304, it is certainly transmitted to the chat server 140. Alternatively, depending on the result of the character string extraction, transmission to the chat server 140 and confirmation and correction by the user can be skipped. For example, in S1210, if a character string can be extracted for all of the attributes (tokens) defined in the file name generating convention, S1211 to S1217 are skipped, and the flow continues from S1218.

Note that FIG. 12 illustrates an example in which the edit based on chat is limited to one time, but edits can be repeatedly performed. In this case, each time input based on chat ends, that is, when S1217 is performed, the flow returns to S1211, and the post-edit extraction result information is transmitted from the MFP cooperative server 120 to the chat server 140. This is repeated until a transmission instruction is input into the chat, and when a transmission instruction is input, the flow from S1218 is executed.

Also, the sequence illustrated in FIG. 12 is an example in which “display on chat service” is selected for the transmission destination information display mode setting 1304. Alternatively, in a case where “do not display” is selected for the transmission destination information display mode setting 1304, for example, when the extraction result of the character string from the scanned image is received from the MFP cooperative server 120, the transmit button 1306 may be displayed in an operational state. Then, when the transmit button 1306 is selected, this is transmitted to the MFP cooperative server 120, the MFP cooperative server 120 attaches the file name generated from the extracted character string to the file including the scanned image and the character string and transmits it to the designated transmission destination server 130.

Also, in a case where “display on MFP” is selected for the transmission destination information display mode setting 1304, for example, when the extraction result of the character string from the scanned image is received from the MFP cooperative server 120, the UI screen illustrated in FIG. 14 is displayed. Then, when the transmit button on this UI screen is selected, this is transmitted to the MFP cooperative server 120, the MFP cooperative server 120 attaches the file name generated from the extracted character string to the file including the scanned image and the character string and transmits it to the designated transmission destination server 130.

### Chat Server Transmission Processing Flow

FIG. 17 is a flowchart illustrating the flow of processing executed by the MFP cooperative server 120 for the sequence of FIG. 12. The present flow starts, in S1210 of FIG. 12, when image analysis is performed by the image processing unit 432 of the MFP cooperative service 120 and characters are extracted. Also, the processing in the MFP in a case where the transmission destination information display mode setting is “display on MFP” will not be described.

The processing will be described in detail following the flow of FIG. 17. Note that hereinafter, the symbol “S” represents the term “step”.

First, in S1701, the image processing unit 432 performs image analysis and extracts a character string. Here, for example, characters included in the image are recognized by optical character recognition. Then, from the recognized character string, the type of the characters, the position of the character string, the surrounding blank area, the delimiter character, and the like are referenced to extract the character string of the corresponding attribute. The type of character, the position of the character string, the surrounding blank area, the delimiter character, and the like may be predefined for each attribute and stored as an attribute dictionary. The target for extraction may be a character string of an attribute corresponding to a token included in the file name naming convention. In a case where there are a plurality of character strings that correspond to one token, one of these may be selected and used in the file name, and the other character string may be associated with an attribute and included in the extraction result information.

In S1702, the data management unit 434 determines whether or not “display via chat service” is set for the transmission destination information display mode setting.

In a case where it is determined that the setting is “display via chat service” in S1702, in S1703, the request control unit 431 transmits the extraction result information to the chat server 140 via an external server access unit. In S1702, in a case where it is determined that the setting is not “display via chat service”, the processing ends.

In S1704, the request control unit 431 determines whether the extraction result correction information has been received from the chat server 140. The extraction result correction information corresponds to input information received in S1217 of FIG. 12.

In a case where it is determined that the extraction result correction information has been received in S1704, in S1705, the request control unit 431 transmits the extraction result information re-generated based on the obtained extraction result correction information to the chat server 140 via the external server access unit. This step corresponds to S1211 of FIG. 12. In other words, in FIG. 12, the processing returns to S1211 from S1217. After S1705, the processing returns to S1704. Note that the chat server 140 that receives the corrected extraction result information does not generate a new chat room and displays the chat based on the corrected extraction result information in the pre-correction chat room.

In a case where it is determined that the extraction result correction information has not been obtained in S1704, in S1706, the request control unit 431 determines whether a file transmission instruction has been received from the chat server 140.

In a case where it is determined that the file transmission instruction has been received in S1706, in S1708, the request control unit 431 transmits the created file to the transmission destination server 130 on the basis of the information obtained from the chat server via the external server access unit. The created file has a file name generated according to the naming convention based on the character string extract from the scanned image or a file name edited via chat. Also, in this example, the transmission destination server 130 designates the transmission destination, but a designated transmission destination does not a fixed destination.

In a case where it is determined that the extraction result correction information has not been obtained in S1706, in S1707, the request control unit 431 determines whether a file transmission cancel instruction has been received from the chat server 140. In a case where it is determined that a file transmission cancel instruction has been received in S1707, in S1709, the request control unit 431 stops the transmission processing for the file. All of the information relating to the file for which file transmission processing has been canceled maybe discarded. In the present example, what is received from the chat server 140 is either a transmission instruction or a cancel instruction, and in other cases, the processing waits for the reception of either of these instructions. However, it may be configured to execute processing according to the instruction.

In S1707, in a case where it is determined that a file transmission cancel instruction has not been obtained, the flow returns to S1704.

In S1702, in a case where “display on chat server” is not selected, in S1710, it is determined whether “display on MFP” has been selected. In a case where “display on MFP” has been selected, in S1711, the extraction result is transmitted to the MFP 110. Having received this, the MFP 110 displays an UI screen such as that illustrated in FIG. 14. Also, if a transmission instruction from the MFP is being waited for and then it is determined to have been received in S1712, in S1708, the file is transmitted to the designated transmission destination.

In a case where “display on MFP” has not been selected in S1710, it is determined that “do not display” has been selected. The flow branches to S1712, and the processing waits for the reception of a transmission instruction corresponding to the press of the transmit button 1306.

### Processing Process by Chat Bot

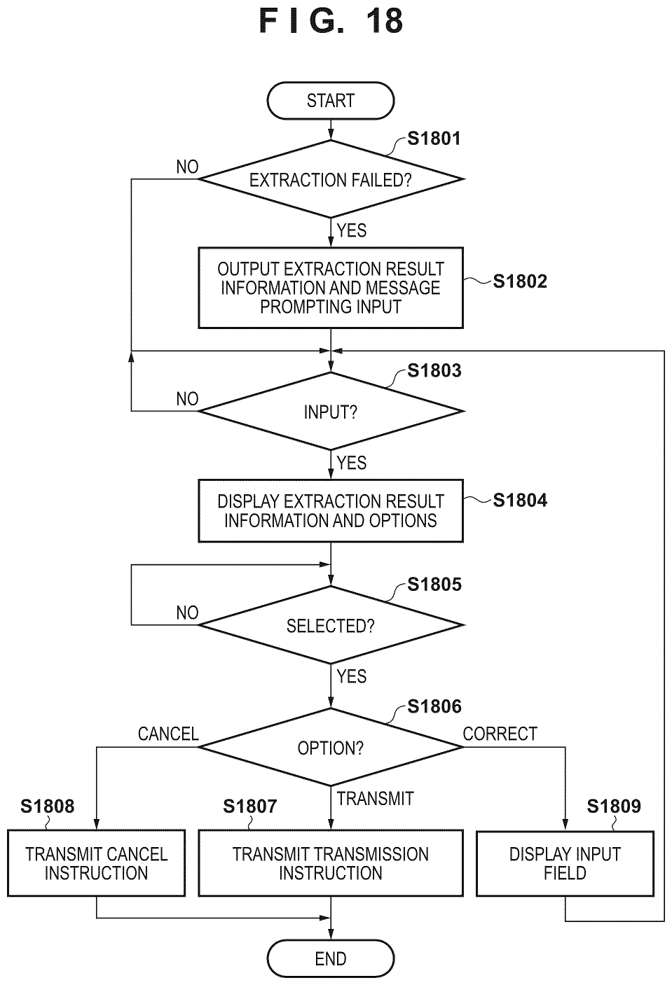

The processing process by the chat server 140, in particular the CPU 311, illustrated in FIG. 12 will now be described briefly with reference to FIG. 18. The processing of FIG. 18 starts when extraction result information is received. First, it is determined whether a character string of an attribute could not be extracted according to the file name naming convention, that is, whether extraction failed (S1801). In the case of failure, the extraction result information is displayed as in FIG. 15, a message prompting for the input of the character string that could not be extracted is also displayed, and the processing waits for input (S1802). If extraction was not a failure in S1801, S1802 is skipped. Next, it is determined whether there has been the input which is being waited for (S1803). If there has been input, the extraction result information is displayed according to the input, options for the user relating to the extraction result information is also displayed (S1804), and the processing waits for input (S1806). The options include, for example, a transmission instruction, a cancel instruction, an extraction result correction instruction, and the like. If there is input, it is determined what was selected (S1806). In the case of a transmission instruction, the input information and the transmission instruction are transmitted together to the MFP cooperative server 120 (S1807). In the case of a cancel instruction, the cancel instruction is transmitted to the MFP cooperative server 120 (S1808). In the case of a correction instruction, an input field (chat input field) for inputting the correction content is displayed (S1809), and the processing branches to S1803 and waits for input.

Note that in the process described above, in the waiting for input step, an instruction to suspend the processing may be received in any step.

With the configuration and process described above, according to the information processing system of the present embodiment, a character string of an attribute designated by a token can be extracted from image data obtained by scanning a document, and a character string corresponding to a file name can be generated in accordance with a designated convention. Also, the extracted character string is presented to the user via chat, and if there is content that needs to be edited, such as corrections, selection of a corrected character string or input is accepted. Accordingly, the extracted character string can be confirmed and changed via chat without needing the user to have exclusive access to the MFP after the scan. Also, since the input of the corrected character string is accepted in the chat, compared to a case where the input is accepted on an MFP with poor performance compared to a general-purpose computer in terms of processing power and user interface, the user can quickly perform the correction operation. Thus, the correction operation can be made easier, the work efficiency can be enhanced, and productivity can be enhanced. Also, when the MFP has low processing power but is used for the character string extraction processing, it takes a significant amount of time for the extracted character string to be displayed. In the present example, the scanned image analysis and character string extraction are executed in the MFP cooperative server 120. Thus, the character string can be extracted in less time than when the processing is executed in the MFP, and confirmation can be performed via the chat.

### Second Embodiment

The second embodiment of the present invention will be described below. For the second embodiment, only the differences with the first embodiment described above will be described, and sections that not described have the same configuration/process as in the first embodiment.

In the first embodiment described above, on the screen of the chat service, an attribute value is manually input when character string extraction fails. However, in the second embodiment, a plurality of extracted character strings are displays as options, and the selected extracted character string is set as the attribute value.

FIG. 16 is an example of an extraction result information confirmation screen 1600 displayed on the operation unit 317 of the client PC 111. This example is a result of extraction from a scanned document image 1302 of FIG. 13. For the “document creation date” of the extraction result, “20171029” is displayed. The correct document creation date (issued date) is “20170929”, but the “expiration date” of “20171029” has been mistakenly extracted. As an option of a chat 1601 of an action after the extraction character string is set, “correct extraction result” is displayed. When “correct extraction result” is selected, a chat 1602 is displayed, and the attribute name can be selected to correct the corresponding attribute value. At this time, the attributes that can be selected are attributes set via automatically extracted tokens.

When “document creation date” is selected, a chat 1603 is displayed, and candidate extracted character strings relating to the target attribute, that is, attribute values, can be selected. In the present embodiment, since the “document creation date” automatically extracted token is set, the character string extracted from the date information included in the scanned image, that is, the character strings “20170929” and “20171029” with a date as an attribute, as displayed as options. When the user selects the correct document creation date “20170929”, the extraction result and the transmission destination information are re-generated using the selected character string and entered into the chat.

Here, with the process of FIG. 17, when the extraction result information is corrected, the corrected extraction result information, for example, the selected character string, is transmitted from the chat server 140 to the MFP cooperative server 120. Then, the corrected extraction result information with the corrected character string is transmitted from the MFP cooperative server 120 to the chat server 140. The chat server 140 displays the corrected extraction result information is displayed in the pre-correction chat room. Also, in a case where “manual input” is selected in the chat 1603, manual input can be performed in the chat input field. At this time, the option display unit is assumed to be a function of the chat service, API, a plug-in, or the like, but it is not particularly limited.

According to the second embodiment, an attribute value can be easily corrected by displaying a plurality of extracted character strings as options.

The chat illustrated in FIG. 16 is implemented by the chat server 140. With the process of FIG. 18, for example, instead of simply displaying a user input field in S1809, the chat 1602 is displayed showing the attributes corresponding to the tokens described in the file name naming convention as candidates for attributes to be corrected. Also, when an attribute is selected, of the extracted character strings, the character string of the selected attribute is displayed as a candidate. When a character string is selected from these candidates, the character string is set as the input character string, and the processing branches to S1803.

### Modified Examples

In the first and second embodiment, as illustrated in S1704 and S1705 of FIG. 17, the chat server 140 transmits the extraction result information each time it is corrected to the MFP cooperative server 120, the corrected extraction result information is received from the MFP cooperative server 120, and chat is continued.

Alternatively, without executing S1704 and S1705, the chat server 140 may perform correction according to the user input of the extraction result information until a transmission instruction is input by the user into the chat. In this case, S1212 to S1216 of FIG. 12 are repeated, an input by the user is accepted by the chat, and the result is displayed. In this manner, the frequency of communication between the MFP cooperative server 120 and the chat server 140 can be decreased, thus allowing the processing to be sped up and the productivity enhanced.

Also, in the first and second embodiment described above, regardless of whether the character string extraction succeeds or fails, in a case where “display on chat server” is set, the extraction result information is transmitted to the chat server 140. Alternatively, even if “display on chat server” is set, in a case where all of the character strings of the designated attributes can be extracted according to the file name naming convention, the information may not be transmitted to the chat server 140. In this case, the processing may be the same as when “do not display” is selected from the transmission destination information display mode setting 1304.

Also, in the first and second embodiment described above, the MFP 110 and the MFP cooperative server 120 are different apparatuses. However, the MFP 110 may include the functions of the MFP cooperative server 120. This configuration may be referred to as the MFP cooperative server 120 including a scanner.

Also, in the first and second embodiment described above, the MFP 110 and the chat server 140 are different apparatuses. However, the MFP 110 may include the functions of the chat server 140.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131467, filed Aug. 10, 2023 which is hereby incorporated by reference herein in its entirety.

What is claimed is:

1. An image processing apparatus that can communicate with a server providing a chat service, comprising:
at least one memory storing instructions; and
at least one processor that is in communication with the at least one memory and that, when executing the instructions, cooperates with the at least one memory to execute processing, the processing including
obtaining image data of a digitalized document,
transmitting a character string obtained via character recognition processing on the image data to the server and receive a correction for the character string from the server, and
correcting the character string according to the correction, and
the character string is used in information for identifying a file including the image data from which the character string was extracted.

2. The image processing apparatus according to claim 1, further comprising:
a scanner that digitalizes documents.

3. The image processing apparatus according to claim 1, further comprising:
a user interface, wherein
a user selects to transmit the character string to the server via the user interface, and the character string is transmitted to the server according to the selection.

4. The image processing apparatus according to claim 1, wherein
the processing further includes extracting a character string of an attribute according to a convention designated in advance and generating a new character string according to the convention on a basis of the character string obtained via extraction.

5. The image processing apparatus according to claim 4, wherein
the character string obtained via the extraction is a character string of an attribute according to a convention designated in advance, and a new character string is generated according to the convention on a basis of the character string extracted, and
when the server receives the character string extracted in a case where a character string of an attribute has been unable to be extracted according to the convention, a message is displayed prompting for input of the character string that was unable to be extracted.

6. The image processing apparatus according to claim 4, wherein
the character string obtained via the extraction is a character string of an attribute according to a convention designated in advance, and a new character string is generated according to the convention on a basis of the character string extracted, and
in a case where all of character strings of attributes has been extracted according to the convention, the server does not accept input of a correction for the character string and does not display the character string.

7. The image processing apparatus according to claim 1, wherein
the server displays an attribute of the character string displayed as an option and accepts input of a correction for a character string of a selected attribute.

8. The image processing apparatus according to claim 7, wherein
of the character strings extracted from the image data, the server displays the character string of the attribute selected as an option and accepts a selected character string as input of a correction for the character string displayed.

9. A control method for an image processing apparatus that can communicate with a server providing a chat service, comprising:
obtaining image data of a digitalized document;
transmitting a character string extracted from the image data to the server and receiving a correction for the character string from the server; and
correcting the character string according to the correction, wherein
the character string is used in information for identifying a file including the image data from which the character string was extracted.

10. A non-transitory computer-readable storage medium storing a program that causes a computer that can communicate with a server providing a chat service to execute processing when loaded and executed on the computer, the processing including:
obtaining image data of a digitalized document,
transmitting a character string extracted from the image data to the server and receiving a correction for the character string from the server, and correcting the character string according to the correction, wherein the character string is used in information for identifying a file including the image data from which the character string was extracted.
